(19) United States
(12) Patent Application Publication
(10) Pub. No.: US 2009/0273425 A1
(43) Pub. Date: Nov. 5, 2009

(54) POWER SUPPLY CENTER

(76) Inventor: John M. Tremaine, New Canaan, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/430,427

(22) Filed: Apr. 27, 2009

Related U.S. Application Data
(60) Provisional application No. 61/125,552, filed on Apr. 25, 2008.

(51) Int. Cl. H01F 27/02

(52) U.S. Cl. 336/90; 361/836

(57) ABSTRACT

The present invention is related to power supply centers. The power supply centers of the present invention may be self-contained modular units. The power supply centers may have between one or more primary taps, a switch or dimmed tap to compensate for losses when dimming. The power supply centers may also have one or more secondary taps to provide secondary voltages of 11-30V depending upon the secondary voltage of the power supply center. Loads may be connected up the one or more secondary taps up to the full watt rating of the power supply center. In accordance with the power supply centers of the present invention, it is possible that loads at varying distances from the power supply center can be tapped on different taps to recover voltage drop and produce between 85% and 100% light output if the lighting system has been wired properly.

### CROSS-REFERENCE TO RELATED APPLICATIONS

This applicant claims priority to U.S. Provisional Application No. 61/125,552 filed Apr. 25, 2008 under 35 U.S.C. § 119(e), which is hereby incorporated by reference in its entirety.

### BACKGROUND OF THE INVENTION

Lighting systems may have multiple applications, such as interior lighting and outdoor lighting. However, due to the nature of electricity dangerous or hazardous conditions may result if lighting systems are not properly installed, or installed in locations with conditions that may adversely impact the functioning of the lighting systems. In general, lighting systems include a power source, luminaires or lights, and a connection between the power source and the lights. The connection may include a device, such as a transformer, to adjust the voltage supplied from the power source depending upon the output of the lights. As discussed above, it is important that any connections between the power source and lights is properly installed and not subjected to adverse conditions that may impact the safety of the lighting system.

For example, Chapter 3 of the NFPA 70: National Electric Code (2005) by the National Fire Protection Association sets out the requirements for Class 1 wiring connections to be used in electrical systems, such as lighting systems. However, it is possible that connections between the power source and loads, such as lights may be improperly made, or subject to adverse conditions, such as weather, water or temperature. Accordingly, it is desirable to provide a connection device that may be used in electrical systems, such as lighting systems, that facilitates the connection of power sources to loads in order to reduce the likelihood of improper connections, and is resistant to a variety of adverse conditions so that the connection device can be used for various applications, such as interior lighting, outdoor lighting and/or underwater lighting.

### SUMMARY OF THE INVENTION

The present invention is related to power supply centers for use in lighting applications, including but not limited to low voltage lighting applications. It is understood that the power supply centers may also be used in other electrical applications in which they are suitable. The power supply centers may have between one or more primary taps to compensate for losses incurred due to low voltage or the like. The power supply centers may also have up one or more secondary taps to provide secondary voltages of 11-30V depending upon the secondary voltage of the power supply center. Loads may be connected to the one or more secondary taps up to the full watt rating of the power supply center. In accordance with the power supply centers of the present invention, it is possible that loads at varying distances from the power supply center can be connected to different taps to recover voltage drop and produce between 85% and 100% light output if the lighting system has been wired properly. The power supply centers are configured and constructed so that they may be modular and self-contained in design. For example, the power supply centers may be configured and constructed so that they are suitable for a variety of applications, such as indoor and/or outdoor applications or wet, submersed, damp or dry applications, and positioned at various locations within an electrical system.

According to a first aspect of the invention a power supply center is provided that may include a casing at least partially defining a bounded region, a first plate dimensioned to substantially cover a first opening of the bounded region, and a second plate dimensioned to substantially cover a second opening of the bounded region. The casing, the first plate and the second plate may at least partially define an interior region of the power supply center, and the interior region may be dimensioned for receipt of a transformer. The power supply center according to the first aspect of the invention may also include a primary side including at least one primary connector configured to connect at least one primary conductor of a primary feed line to the transformer, and a secondary side including at least one secondary connector configured to connect the transformer to at least one secondary conductor of a secondary output line.

In accordance with the first aspect of the invention, the casing may be made from aluminum or an aluminum alloy.

In accordance with the first aspect of the invention, the power supply center may include at least one circuit breaker connected to the at least one secondary connector.

In accordance with the first aspect of the invention, the power supply center may include at least one circuit breaker connected to the at least one primary connector.

In accordance with the first aspect of the invention, the primary connector may include a connector conductor that may include a first end configured for connection to the transformer and a second end configured for connection to the at least one primary conductor of the primary feed line, and the first surface or the second surface of the power supply center may include an opening, and the connector conductor is dimensioned to pass through the opening.

In accordance with the first aspect of the invention, the power supply center may also include a wire cover positioned on the casing, the wire cover may include at least one chamber dimensioned for receipt of the second end of the connector conductor.

In accordance with the first aspect of the invention, the secondary connector may include a connector conductor comprising a first end configured for connection to the transformer and a second end configured for connection to the at least one secondary conductor of the secondary output line, and the first surface or the second surface may include an opening, and the connector conductor may be dimensioned to pass through the opening.

In accordance with the first aspect of the invention, the power supply center may also include a wire cover positioned on the casing, and the wire cover may include at least one chamber dimensioned for receipt of the second end of the connector conductor.

In accordance with the first aspect of the invention, the primary connector may include a terminal block, and the terminal block may include a tubular housing having a passage defined therein, the passage includes a first wall and a second wall parallel to the first wall, a third wall positioned perpendicular to the first wall and the second wall, and a concave surface opposite the third wall, and the passage is dimensioned for receipt of the at least one primary conductor of the primary feed line. The terminal block may also include a pair of holes in the third wall each dimensioned for receipt of a conductor fastening device, and a mounting post receiving opening positioned on a surface of the tubular housing opposite the pair of holes, a distance between the first wall and the second wall may be substantially equal to or slightly larger than a diameter of the conductor fastening device.

In accordance with the first aspect of the invention, the secondary connector may include a terminal block, and the terminal block may include a tubular housing having a passage defined therein, the passage may include a first wall and a second wall parallel to the first wall, a third wall positioned perpendicular to the first wall and the second wall, and a concave surface opposite the third wall, and the passage may be dimensioned for receipt of the at least one secondary conductor of the secondary output line. The terminal block may also include a pair of holes in the third wall each dimensioned for receipt of a conductor fastening device, and a mounting post receiving opening positioned on a surface of the tubular housing opposite the pair of holes, and a distance between the first wall and the second wall may be substantially equal to or slightly larger than a diameter of the conductor fastening device.

In accordance with the first aspect of the invention, the at least one primary connector of the primary side may include a first primary connector, a second primary connector and a third primary connector. The first primary connector may be configured for connection to a ground conductor, and the second primary connector may be configured for connection to a neutral conductor, and the third primary connector may be configured for connection a hot conductor.

In accordance with the first aspect of the invention, the at least one primary connector of the primary side may also include a fourth primary connector configured for connection to the hot conductor, and connected to the transform so as to offset voltage drop.

In accordance with the first aspect of the invention, the at least one secondary connector of the secondary side may include a first secondary connector and a second secondary connector, the first second connector may be connected to the transformer so as to provide a first output voltage, and the second secondary connector may be connected to the transformer so as to provide a second output voltage different from the first output voltage.

In accordance with the first aspect of the invention, the at least one secondary connector of the secondary side may also include a third secondary connector, a fourth secondary connector, and a fifth secondary connector, the third secondary connector may be connected to the transformer so as to provide s a third output voltage different from the first output voltage and the second output voltage, the fourth secondary connector may be connected to the transformer so as to provide a fourth output voltage different from the first output voltage, the second output voltage and the third output voltage, and the fifth secondary connector may be connected to the transformer so as to provide a fifth output voltage different from the first output voltage, the second output voltage, the third output voltage and the fourth output voltage.

In accordance with the first aspect of the invention, the power supply center may also include a third plate dimensioned to substantially cover a third opening of the bounded region, and the casing, the first plate, the second plate and the third plate at least partially define the interior region of the power supply center dimensioned for receipt of the transformer.

In accordance with the first aspect of the invention, the at least one primary connector and/or the at least one secondary connector may each be mounted on the third plate by a threaded connection post, the threaded connection post may be connected to the transformer, and the threaded connection post may be made of a conductive material.

In accordance with the first aspect of the invention, the interior region is at least partially filled with an epoxy resin.

In accordance with the first aspect of the invention, the at least one primary connector and the at least one secondary connector may be made of a conductive material.

According to a second aspect of the invention a power supply center is provided that may include a casing defining a bounded region, a first plate dimensioned to substantially cover a first opening of the bounded region, and a second plate dimensioned to substantially cover a second opening of the bounded region. The casing, the first plate and the second plate define an interior region of the power supply center dimensioned for receipt of a transformer. The power supply center may also include a primary side that may include at least one primary connector configured to connect at least one primary conductor of a primary feed line to the transformer, and a secondary side that may include at least one secondary connector configured to connect the transformer to at least one secondary conductor of a secondary output line. The primary connector of the power supply center may include a connector conductor comprising a first end configured for connection to the transformer and a second end configured for connection to the at least one primary conductor of the primary feed line, and the first surface or the second surface may include an opening, and the connector conductor is dimensioned to pass through the opening.

In accordance with the second aspect of the invention, the interior region is at least partially filled with an epoxy resin.

In accordance with the second aspect of the invention, the casing may be made from aluminum or an aluminum alloy.

In accordance with the second aspect of the invention, the at least one primary connector and the at least one secondary connector may be made of a conductive material.

In accordance with the second aspect of the invention, the power supply center may include at least one circuit breaker connected to the at least one secondary connector.

In accordance with the second aspect of the invention, the power supply center may include at least one circuit breaker connected to the at least one primary connector.

In accordance with the second aspect of the invention, the secondary connector may include a connector conductor comprising a first end configured for connection to the transformer and a second end configured for connection to the at least one secondary conductor of the secondary output line, and the first surface or the second surface may include an opening, and the connector conductor may be dimensioned to pass through the opening.

In accordance with the second aspect of the invention, the power supply center may also include a wire cover positioned on the casing, and the wire cover may include at least one chamber dimensioned for receipt of the second end of the connector conductor.

In accordance with the second aspect of the invention, the at least one primary connector of the primary side may include a first primary connector, a second primary connector and a third primary connector. The first primary connector may be configured for connection to a ground conductor, and the second primary connector may be configured for connection to a neutral conductor, and the third primary connector may be configured for connection a hot conductor.

In accordance with the second aspect of the invention, the at least one primary connector of the primary side may also include a fourth primary connector configured for connection to the hot conductor, and connected to the transform so as to offset voltage drop.

In accordance with the second aspect of the invention, the at least one secondary connector of the secondary side may include a first secondary connector and a second secondary connector, the first second connector may be connected to the transformer so as to provide a first output voltage, and the second secondary connector may be connected to the transformer so as to provide a second output voltage different from the first output voltage.

In accordance with the second aspect of the invention, the at least one secondary connector of the secondary side may also include a third secondary connector, a fourth secondary connector, and a fifth secondary connector, the third secondary connector may be connected to the transformer so as to provide s a third output voltage different from the first output voltage and the second output voltage, the fourth secondary connector may be connected to the transformer so as to provide a fourth output voltage different from the first output voltage, the second output voltage and the third output voltage, and the fifth secondary connector may be connected to the transformer so as to provide a fifth output voltage different from the first output voltage, the second output voltage, the third output voltage and the fourth output voltage.

According to a third aspect of the invention, a power supply center is provided that may include a casing at least partially defining a bounded region, a first plate dimensioned to substantially cover a first opening of the bounded region, a second plate dimensioned to substantially cover a second opening of the bounded region, and a third plate dimensioned to substantially cover a third opening of the bounded region. The casing, the first plate, the second plate and the third plate define an interior region of the power supply center dimensioned for receipt of a transformer. The power supply center may also include a primary side that may include at least one primary connector configured to connect at least one primary conductor of a primary feed line to the transformer, and a secondary side that may include at least one secondary connector configured to connect the transformer to at least one secondary conductor of a secondary output line. The at least one primary connector or the at least one secondary connector may be mounted on the third plate by a threaded connection post, the threaded connection post may be connected to the transformer, and the threaded connection post may be made of a conductive material.

In accordance with the third aspect of the invention, the interior region is at least partially filled with an epoxy resin.

In accordance with the third aspect of the invention, the casing may be made from aluminum or an aluminum alloy.

In accordance with the third aspect of the invention, the at least one primary connector and the at least one secondary connector may be made of a conductive material.

### BRIEF DESCRIPTION OF THE DRAWINGS

Having thus described the invention in general terms, reference will now be made to the accompanying drawings, which are not necessarily drawn to scale, where:

FIG. 1 is an exploded view of an exemplary embodiment of a power supply center according to the present invention,

FIG. 2 is an isometric view of the embodiment of the power supply center shown in FIG. 1,

FIG. 3 is a top view of the embodiment of the power supply center shown in FIG. 1,

FIG. 4 is an exploded view of an exemplary embodiment of a power supply center according to the present invention,

FIG. 5 is an exploded view of the embodiment of the power supply center shown in FIG. 4,

FIG. 6 is an isometric view of the embodiment of the power supply center shown in FIG. 4,

FIG. 7 is a top view of the embodiment of the power supply center shown in FIG. 4,

FIG. 8 is an isometric view of an exemplary embodiment of a power supply center according to the present invention,

FIG. 9 is a top view of the embodiment of the power supply center shown in FIG. 8,

FIG. 10 is an exemplary embodiment of a strap handle that may be used with the present invention,

FIG. 11a is a top view of an embodiment of a primary junction box cover that may be used with the present invention,

FIG. 11b is a side view of the primary junction box cover,

FIG. 11c is a bottom view of the primary junction box cover,

FIG. 11d is an isometric view of the primary junction box cover,

FIG. 11e is a close up view of a primary junction box of the power supply center of FIG. 1,

FIG. 12a is an exploded view of the components for an exemplary connector that may be used with the present invention,

FIG. 12b is an assembled view of the components shown in FIG. 12a,

FIG. 13a is a bottom view of the components shown in FIG. 12a,

FIG. 13b is a longitudinal side view of the components shown in FIG. 12a,

FIG. 13c is a top view of the components shown in FIG. 12a,

FIG. 13d is a side view of the components shown in FIG. 12a,

FIG. 13e is a cross-sectional view of the components shown in FIG. 12a,

FIG. 14a is a top view of a terminal block that may be used with the present invention,

FIG. 14b is a front view of the terminal block that may be used with the present invention,

FIG. 14c is a bottom view of the terminal block that may be used with the present invention,

FIG. 14d is a side view of the terminal block that may be used with the present invention,

FIG. 15 is an isometric view of an exemplary embodiment of a power supply center according to the present invention, and

FIG. 16 is an exploded view of the power supply center shown in FIG. 15.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout increased by 100 when referring to different embodiments of the invention.

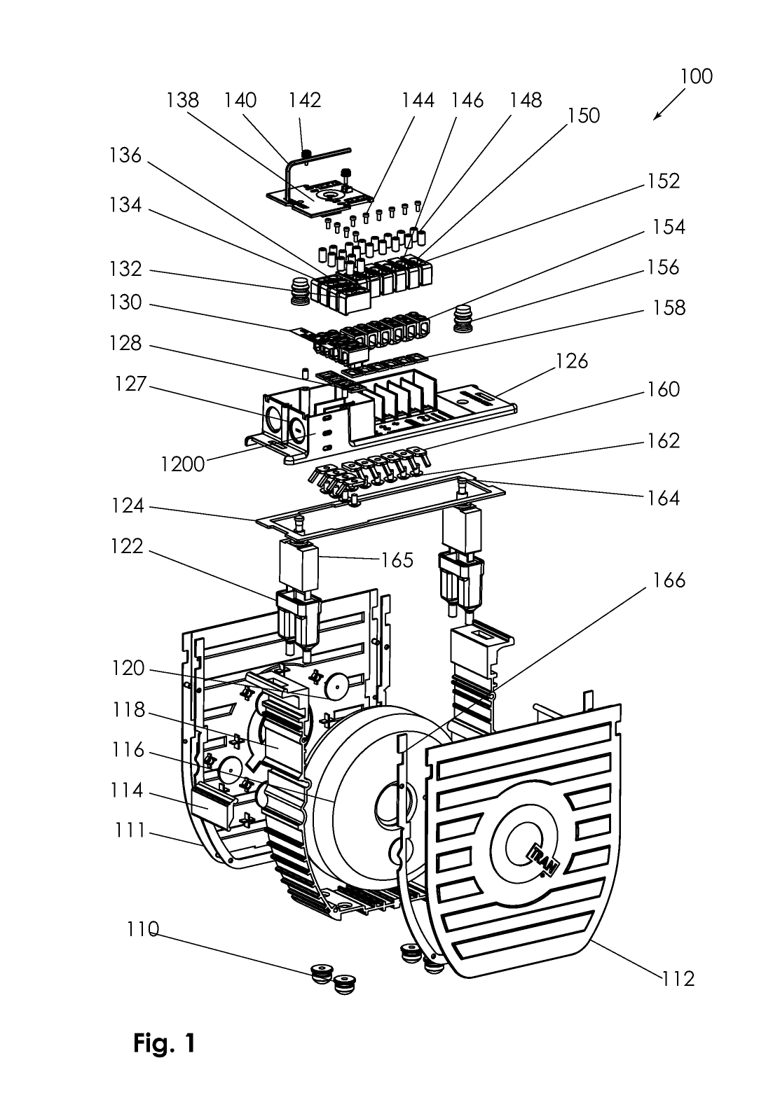

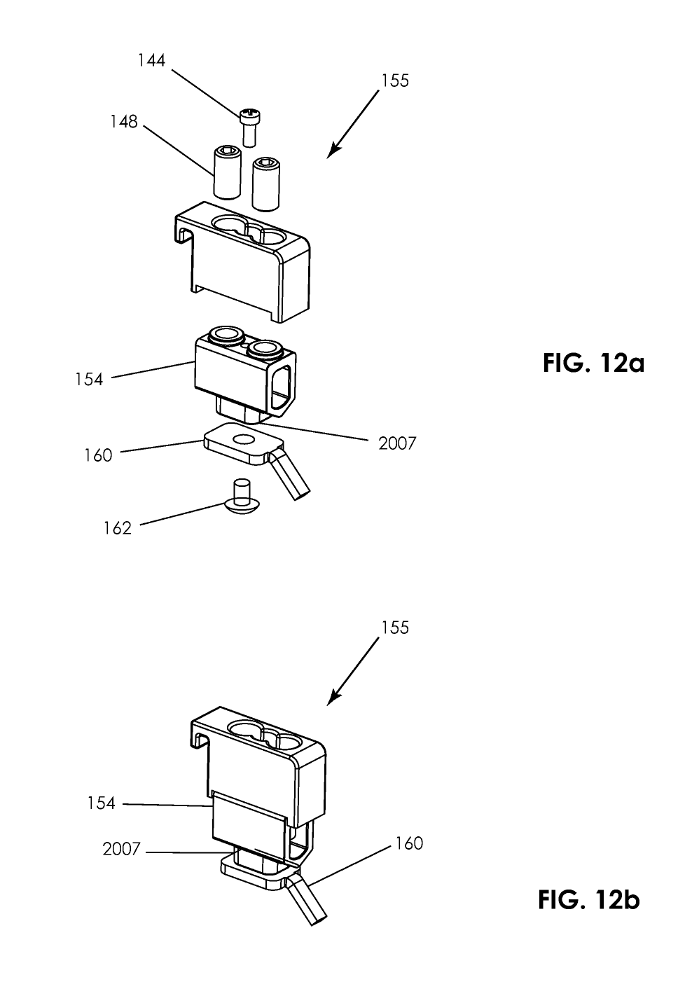

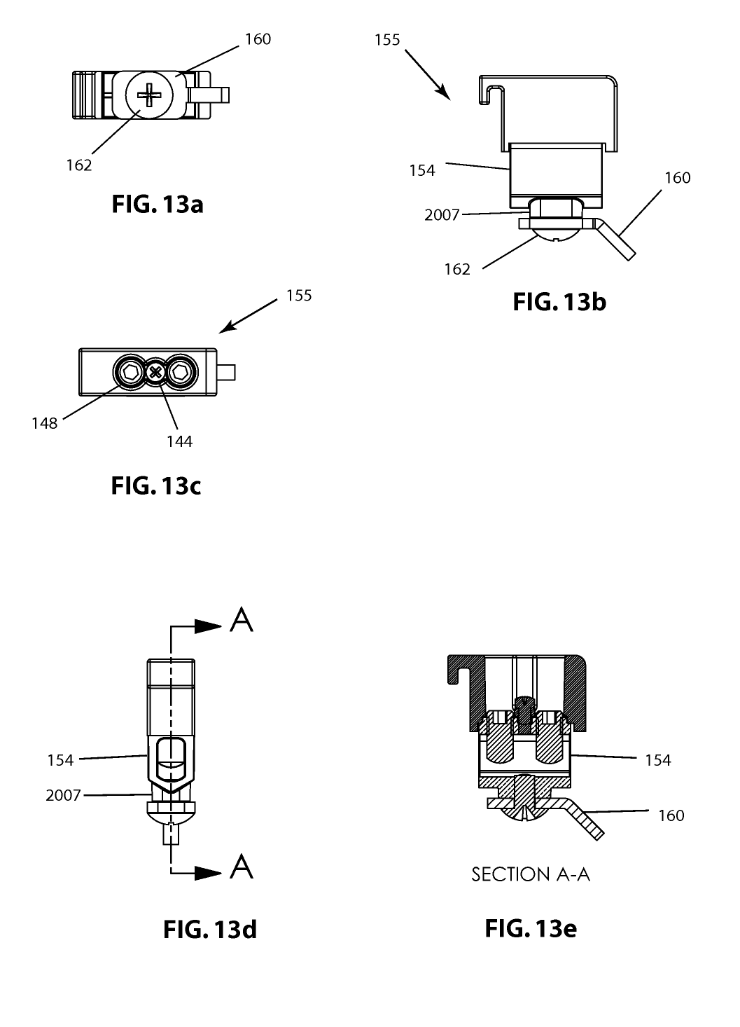

FIG. 1 shows an exemplary embodiment of a power supply center 100 according to the present invention. The power supply center 100 may be configured to receive a primary voltage between 120-277V at 50 Hz or 60 Hz, and configured to output one or more secondary voltages between 11-30V. The power supply center 100 may contain a transformer 116, which may be a 10-1200 volt amps (VA) transformer. The transformer 116 may be a toroidal transformer, or the like, but it is understood that other forms of transformers may also be used with the present invention. The power supply center 100 may include a primary side connected to the transformer 116 and configured to receive a primary voltage between 120-277V at 50 Hz or 60 Hz, and a secondary side connected to the transformer 116 and configured to output one or more secondary voltages between 11-30V. The transformer 116 may include an internal auto-reset thermal breaker to disconnect the primary side if there is an overload or an improper connection, such as an improper dimmer connection. The primary side and the secondary side each include at least one connector 155, as shown in detail in FIGS. 12a-13e. It is understood that the connector 155 is comprised of the components shown in FIGS. 12a-13a, and which are identified by appropriate reference numerals and shown in an exploded view in FIG. 1. Therefore, connector 155 is not specifically called out by a reference numeral in FIG. 1. The connector 155, as shown in FIGS. 12a-13e, may be configured to connect at least one conductor (not shown) of a primary feed line (not shown) to the transformer 116 as shown in FIG. 1, and may also be configured to connect at least one conductor (not shown) of a secondary output line (not shown) to the transformer 116. It is understood that the present invention is not limited to any particular transformer 116 configuration or transformer 116 connection to the connectors 155 of the power supply center 100.

Referring to FIG. 1, the transformer 116 is positioned in an interior region of the power supply center 100. The interior region may be formed from two side plates 111, 112 positioned on each side of the transformer 116, and a U-shaped casing 118 or side wall positioned between to the two side plates 111, 112. The casing 118 at least defines a bounded region that includes at least the interior region of the power supply center 100. The casing 118 may be formed from two half U's joined together by a gasket (not shown) at the bottom-center of the casing 118. The casing 118 may be made from an extruded aluminum alloy, such as 60/63-T6 Aluminum Alloy or equivalent. The use of aluminum alloy for the casing 118 aids in the dissipation of heat from the power supply center, however it is understood that the casing 118 may be made from other materials such as plastics or a polycarbonate resin thermoplastic.

As shown in FIG. 1, the side plates 111, 112 may be dimensioned to substantially cover a first and second side of the bounded region defined by the casing 118. The side plates 111, 112 may be made from polycarbonate resin thermoplastic, such as LEXAN® 221 or equivalent. Each side plate 111, 112 may contain one or more epoxy lock disks 120 positioned on the surface of the side plate 111, 112 facing the transformer 116. The epoxy lock disk 120 may be made from polycarbonate resin thermoplastic, such as LEXAN® 221 or equivalent. The epoxy lock disk 120 acts as a surface for epoxy to surround and secure to during construction of the power supply center 100. The epoxy lock disk 120 secures the side plates 112 when epoxy is inserted into the interior region of the power supply center 100. Positioned between each of the side plates 111, 112 and the casing 118 is a gasket 166, which may be made from ethylene propylene diene monomer (EPDM) die cut Shore A30 or equivalent. The gasket 166 serves as a seal between the side plates 111, 112 and side wall 118 to prevent leakage of epoxy during construction of the power supply center 100. The gasket 166 also aids in the prevention of water or other liquid penetration into the interior region of the power supply center 100 when the power supply center 100 is in use.

The power supply center 100 may also include a top cover 126 positioned on an upper opening of the interior region power supply center 100 defined by the casing 118 and side plates 111, 112. A top cover gasket 124 may be placed between the top cover 126 and the upper surfaces of the casing 118 and side plates 111, 112 to prevent leakage of epoxy during construction of the power supply center 100. The top cover gasket 124 may be made from ethylene propylene diene M-class rubber (EPDM) die cut shore A30 or equivalent. The top cover gasket 124 may also prevent water seepage into the power supply center 100 during use of the power supply center 100. The power supply center 100 may also include one or more flap wing supports 114 pivotably connected to the casing 118. The one or more flap wing supports 114 may be made from 60/63-T6 aluminum alloy or equivalent. The one or more flap wing supports 114 may be used to aid in the installation of the power supply center 100 by supporting the power supply center 100 at a desirable location within an enclosure (not shown) before the power supply center 100 is finally positioned within the enclosure. The power supply center 100 may also include one or more feet 110 positioned on a bottom surface of the side wall 118. The one or more feet 110 may be made from generic rubber or equivalent. The power supply center 100 may include a primary circuit breaker 165 and a secondary circuit breaker 164. The primary circuit breaker 165 and the secondary circuit breaker 164 may be 5A-25A circuit breakers. The primary circuit breaker 165 and/or the secondary circuit breaker 164 may be a hydraulic magnetic push/pull circuit breakers, such as a circuit breaker from AIRPAX . Each primary circuit breaker 165 and secondary circuit breaker 164 may include a circuit breaker bottom boot 122 to prevent epoxy leakage into the primary circuit breaker 165 and secondary circuit breaker 164 during construction of the power supply center 100. The circuit breaker bottom boot 122 may be made from frosted silicone or equivalent. The portion of the secondary circuit breaker 164 and primary circuit breaker 165 extending through the top cover 126 may be covered by a circuit breaker push/pull boot 156 made from silicon, such as platinum cure silicon A50 or equivalent.

The connection of the primary side and the secondary side of the power supply center 100 will now be described with reference to FIGS. 1 and 12a-14d. The connector 155 shown in detail in FIGS. 12a-13e is configured to connect to the appropriate conductors (not shown) of the transformer 116 so that the connectors 155 positioned on the primary side of the power supply center 100 can connect to conductors of a primary feed line (not shown) that may have a voltage between 120-277V, and so that the connectors 155 positioned on the secondary side of the power supply center 100 can connect to conductors of a secondary output line (not shown) to provide voltages between 11-30V. It is understood that the voltages discussed with this embodiment of the invention are merely exemplary, and the power supply center 100 may be configured for receipt and output of numerous voltages depending upon the transformer 116 used with the power supply center 100. It is further understood that a full load may be connected to any one connector on the secondary side of the power supply center 100, at least up to the full wattage rating of the power supply center 100.

As shown in FIGS. 1 and 12a-13e, the connector 155 includes a terminal block 154, a lug 160, and a mounting post 162 that is configured to connect the lug 160 to the terminal block 154. As shown in FIG. 1, the mounting post 162 of the connector 155 is placed through an opening (not shown) in the top cover 126, and acts to attach the terminal block 154 to the top cover 126. The top cover 126 may include one or more openings (not shown) positioned so as to allow the mounting post 162 to pass through the top cover 126 and engage the terminal block 154. The mounting post 162 may be threaded so as to securely fasten the terminal block 154 to the top cover 126. The mounting post 162 may be made from a conductive material. The lug 160 may also be made from a conductive material, such as copper, a copper alloy or equivalent, and the lug 160 is connected to the terminal block 154 by the mounting post 162. FIG. 13e provides a cross-sectional view of the connector 155 showing how the mounting post 162 connects the lug 160 to the terminal block 154. The lug 160 may be used to crimp or weld wires (not shown) from the transformer 116 to appropriate locations on the power supply center 100, so that the wires (not shown) are positioned on either the primary side or the secondary side of the power supply center 100.

Although not shown in FIGS. 12a-13e, it is understood that the top cover 126 may be positioned between the terminal block 154 and the lug 160. An epoxy seal gasket 158 as shown in FIG. 1, may also be positioned between the terminal block 154 and the top cover 126. The epoxy seal gasket 158 may be made from ethylene propylene diene M-class rubber (EPDM) die cut shore A40 or equivalent. The epoxy seal gasket 158 may prevent epoxy leakage during construction of the power supply center 100, and may prevent water seepage into the interior region of the power supply center 100 when the power supply center 100 is in use. The epoxy seal gasket 158 may also serve as a compression device between the terminal block 154 and top cover 126 to aid in securing the lug 160 and the terminal block 154 to the top cover 126.

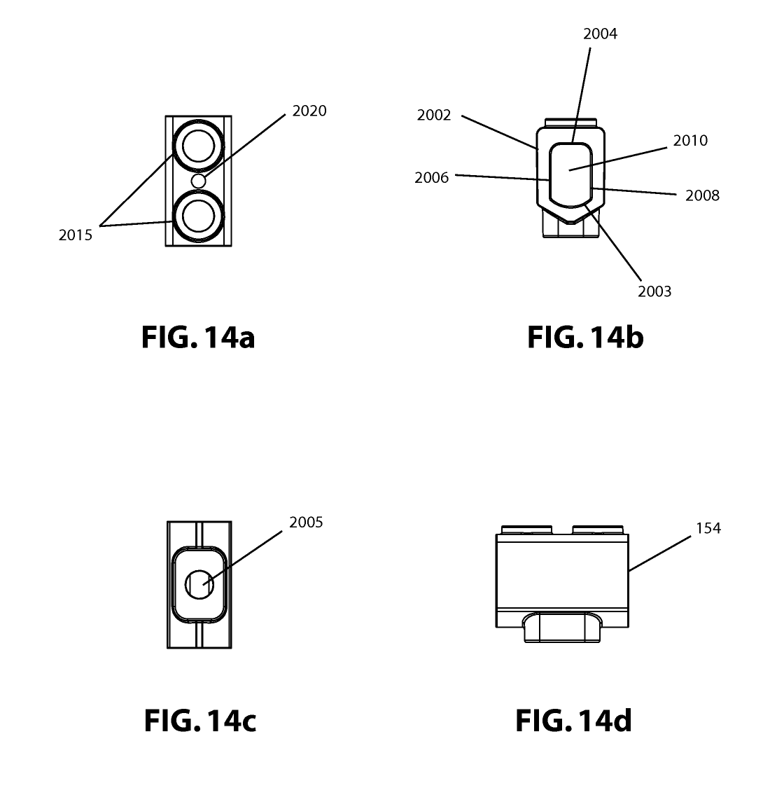

The terminal block 154 of the connector 155 is shown in detail in FIGS. 14a-14d. The terminal block 154 may be made from a tubular housing 2002 that has a passage 2010 defined therein. The passage 2010 may run longitudinally from a first side of the terminal block 154 to a second side of the terminal block 154. The passage 2010 includes a first wall 2006 and a second wall 2008 positioned at least substantially parallel to the first wall 2006. The passage 2010 may further include a third wall 2004 positioned perpendicular to the first wall 2006 and the second wall 2008. The passage 2010 may also include a concave surface 2003 positioned opposite the third wall 2004. The terminal block 154 may include a pair of holes 2015 that are each dimensioned for receipt of a conductor fastener 148 (see e.g. FIGS. 1 and 12a). The conductor fastener 148 may be in the form of a threaded set screw, and may have a hexagonal cavity on a first surface. The conductor fastener 148 may have a convex surface opposite the top surface. The conductor fastener 148 may be made from stainless steel or equivalent. The pair of holes 2015 may each be threaded to securely receive the conductor fastener 148. The pair of holes 2015 each extends from an outer surface of the terminal block 154 through the third wall 2004 of the passage 2010. The distance between the first wall 2006 and the second wall 2008 may be substantially equal to the diameter of the conductor fastener 148. It is of course understood that the distance between the first wall 2006 and the second wall 2008 should be at least slightly larger than the diameter of the conductor fastener 148 so that the conductor fastener 148 is able to be inserted through one of the pair of holes 2015, and extend into the passage 2010 of the terminal block 154. The terminal block 154 may also include a mounting post receiving opening 2005 as shown in FIG. 14c. The mounting post receiving opening 2005 is configured to receive the mounting post 162 shown for example in FIG. 12a. The mounting post receiving opening 2005 may be threaded to securely engage the mounting post 162, if the mounting post 162 is so threaded. The terminal block 154 may also include a structure 2007 extending from the tubular housing 2002, and positioned on the side of the tubular housing 2002 substantially opposite the side of the tubular housing 2002 containing the pair of holes 2015. The mounting post receiving opening 2005 may pass through from a substantially flat surface of the structure 2007 into the passage 2010 of the terminal block 154.

Still referring to FIGS. 14a-14d, the passage 2010 may be dimensioned for receipt of conductors (not shown) of primary or secondary wires that are to be connected to the power supply center 100. The passage 2010 of terminal block 154 may be dimensioned to receive two #8 American wire gauge (AWG) conductors, four #10 AWG conductors, five #12 AWG conductors or seven #14 AWG conductors, however it is understood that the invention is not limited to such dimensions. The connection terminal block 154 may be made from a conductive material, for example 70/30 brass or equivalent, and may have a tin or nickel plating or equivalent to reduce oxidation. In operation, one or more conductors (not shown) are inserted into the passage 2010 of the terminal block 154, and each of the conductor fasteners 148 are moved towards the concave surface 2003 of the passage to secure the one or more conductors (not shown) between the conductor fasteners 148 and the concave surface 2003. The dimensions of the conductor fasteners 148 relative to the dimensions of passage 2010 allow for a secure connection between the conductors and the terminal block 154, even if the conductors are stranded since the dimensions of the passage 2010 may prevent splaying of the strands of the conductor.

Still referring to FIGS. 14a-14d, the terminal block 154 may also include a threaded opening 2020, which may be positioned on the same surface as the pair of holes 2015. The threaded opening 2020 is dimensioned for receipt of a fastener 144 as shown in FIG. 1 and FIG. 12a. The fastener 144 may be in the form of a screw, for example a machine screw, and configured to removably affix a terminal block cover 132, 134, 136, 146, 150, 152 to the terminal block 154. The terminal block covers 132, 134, 136, 146, 150, 152 may be made from an insulating material, such as polycarbonate resin thermoplastic, for example LEXAN® 221 or equivalent.

Referring now to FIG. 1, the terminal block covers 132, 134, 136, 146, 150, 152 may be color coded depending on which terminal block 154 the covers are positioned on. For example, terminal block covers 132, 134, 136 are positioned on terminal blocks 154 of the connectors 155 on the primary side of the power supply center 100. The power supply center 100 may include three or more terminal blocks 154, and in turn three or more connectors 155 on the primary side. One connector 155 on the primary side may be configured to connect a ground conductor (not shown) to the power supply center 100. Another connector 155 may be configured to connect a neutral conductor (not shown) to the power supply center 100. Another connector 155 may be configured to connect a hot conductor (not shown) to the power supply center 100 and this connector 155 may act as a primary tap. A fourth connector 155 may be configured to connect the hot conductor (not shown) to the power supply center 100, so as to act as a second primary tap to compensate for losses that may be incurred due to connection to a dimmer (not shown). The connection of these connectors 155 to the appropriate wires (not shown) of the transformer 116 so that each connectors 155 can be used as discussed above is understood to one of skill in the art. Furthermore, it is understood that the terminal block covers 132, 134, 136 may be color coded to standard colors depending upon the terminal block 154 that the terminal block covers 132, 134, 136 are affixed to. For example, the terminal block cover 132, 134, 136 positioned on the terminal block 154 of the connector 155 for the ground conductor (not shown) may be colored green. The transformer 116 may include a grounded isolation barrier that may be configured to be connected to the connector 155 for the ground conductor (not shown).

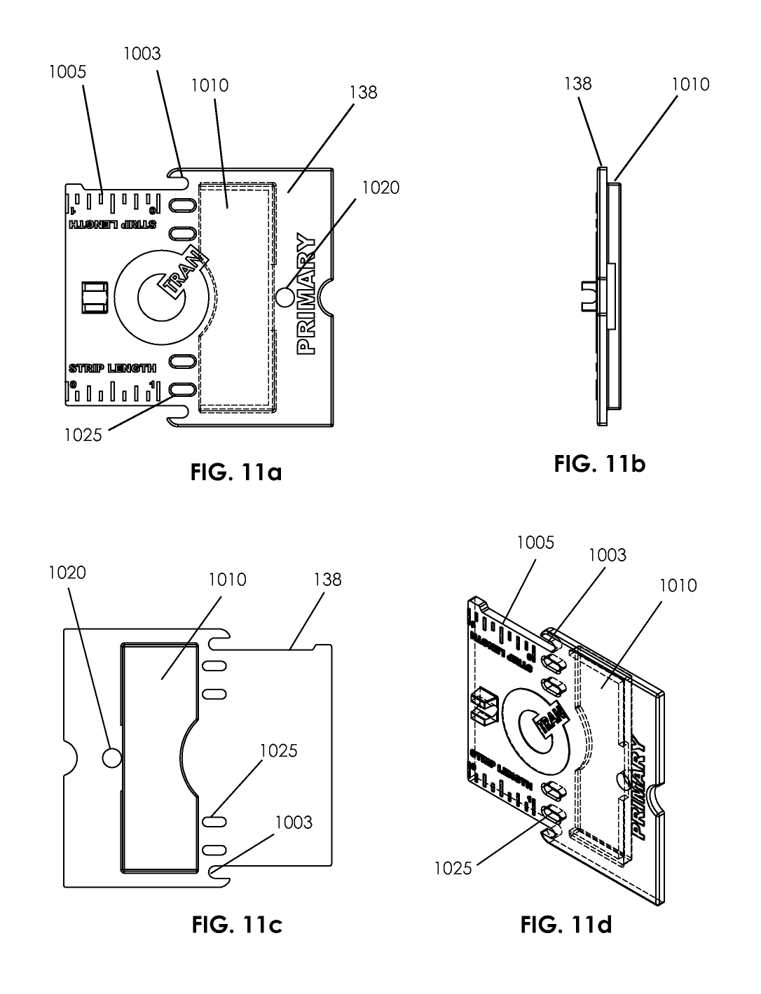

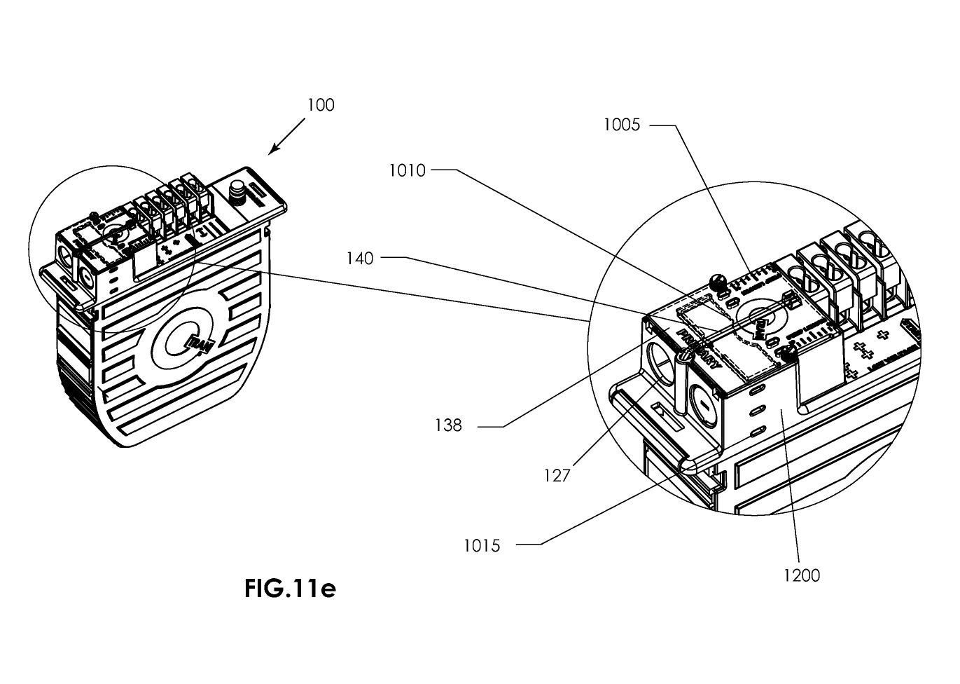

The each of the connectors 155 for the primary side of the power supply center 100 may be positioned within an enclosure 1200 on the top cover 126. As shown in Figure le, the enclosure 1200 may have one or more wire tie slots 1015 for managing feeds to the connectors 155 of the primary side. The enclosure 1200 may also have at least one primary line opening 127 dimensioned to receive a primary feed line. The enclosure 1200 may have a primary cover 138 made from polycarbonate resin thermoplastic, such as LEXAN® 940A or equivalent. As shown in FIGS. 11a, 11b, 11c, and 11d the primary cover 138 may include one or more strip length guides 1005. Positioned on the underside of the primary cover 138 may be a vinyl primary label 130 made from vinyl paper. The vinyl primary label 130 may be used for field notes, and is removably positioned into a pocket 1010 molded on the underside of the primary cover 138. The primary cover 138 may include one or more openings 1025 to allow wire ties to be passed through the primary cover 138. The primary cover 138 may also include an opening 1020 to allow the primary circuit breaker 165 to be reset without removal of the primary cover 138.

Referring again to FIG. 1, the primary cover 138 may be secured to the enclosure 1200 by one or more thumb screws 142 that may screw into one or more knurled plastic inserts 128 set into holes formed in the enclosure 1200. The primary cover 138 may be configured so that it is not necessary to completely remove the thumb screws 142 in order to remove the primary cover 138. For example as shown in FIGS. 11a, 11c and 11d, the primary cover 138 may include one or more open-ended slots 1003 dimensioned to allow the primary cover 138 to be held to the enclosure 1200 by the thumb screws 142. The thumb screw 142 may be made from nylon or equivalent, and the knurled plastic inserts 128 may be made from brass or equivalent. Referring again to FIG. 1, a hexagonally shaped tool 140, for example an Allen key may be positioned on the primary cover 138, and the tool 140 may be used on the conductor fastener 148 during installation or removal or wiring from the power supply center 100. The tool 140 dimensioned to fit the hexagonal cavity of the conductor fastener 148.

The secondary side of the power supply center 100 may include one or more connectors 155, and terminal block covers 146, 150, 152 positioned on the terminal blocks 154 of the connectors 155. The each of the connectors 155 of the secondary side may be connected to the transformer 116 so as to be used as secondary taps. The power supply center 100 shown in FIG. 1 may include one to five secondary taps, and the secondary taps can provides nominal secondary voltages between 11-30V. However, it is understood that the invention is not limited by the number of taps or the secondary voltages provided by the taps. Loads connected to secondary conductors (not shown) of secondary output lines (not shown) may be connected to one or more of the secondary taps, i.e. connectors 155, up to the full watt rating of the power supply center 100. Accordingly, loads at varying distances from the power supply center 100 can be connected to different taps to recover voltage drop and produce between 85-100% light output.

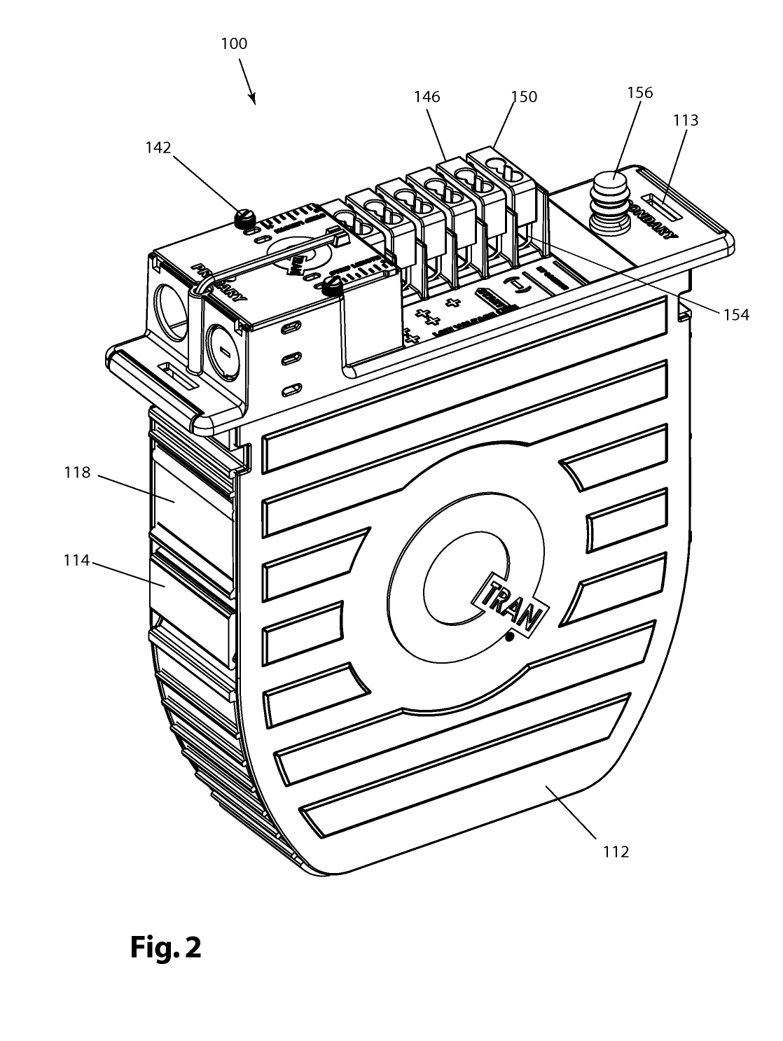

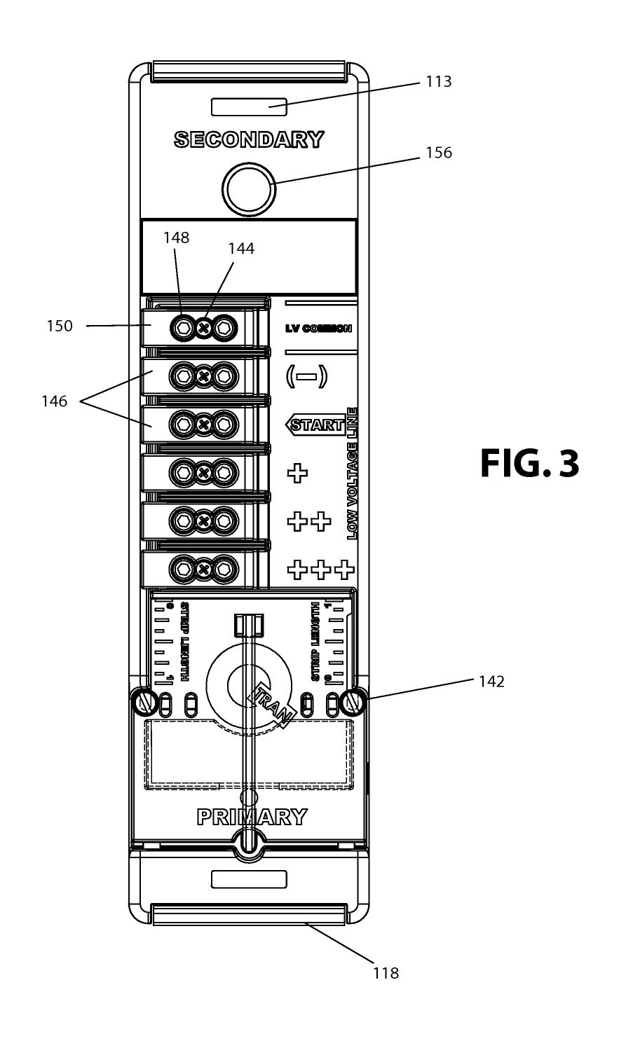

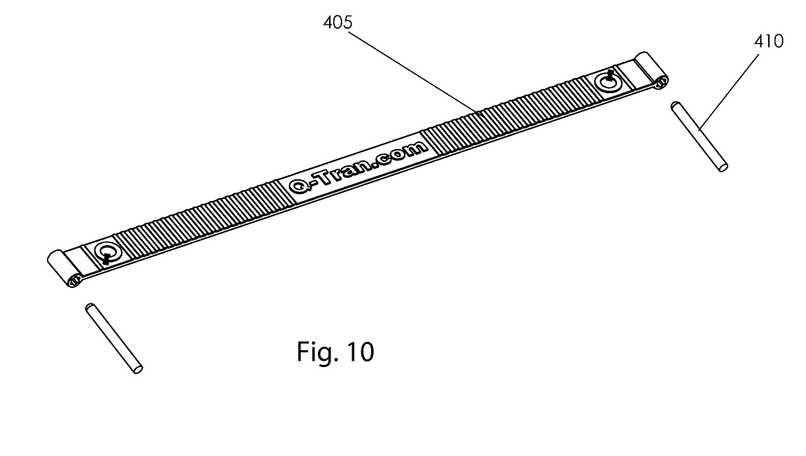

FIGS. 2 and 3 show the assembled power supply center 100 as shown in FIG. 1. Opening 113 in the top cover 126 may be used for a handle strap 405 as shown in FIG. 10. The handle strap 405 may be made from rubber or equivalent, and is secured to the top cover 126 by rods 410 on either end of the handle strap 405. The rods 410 may be made from 18-8 stainless steel or equivalent.

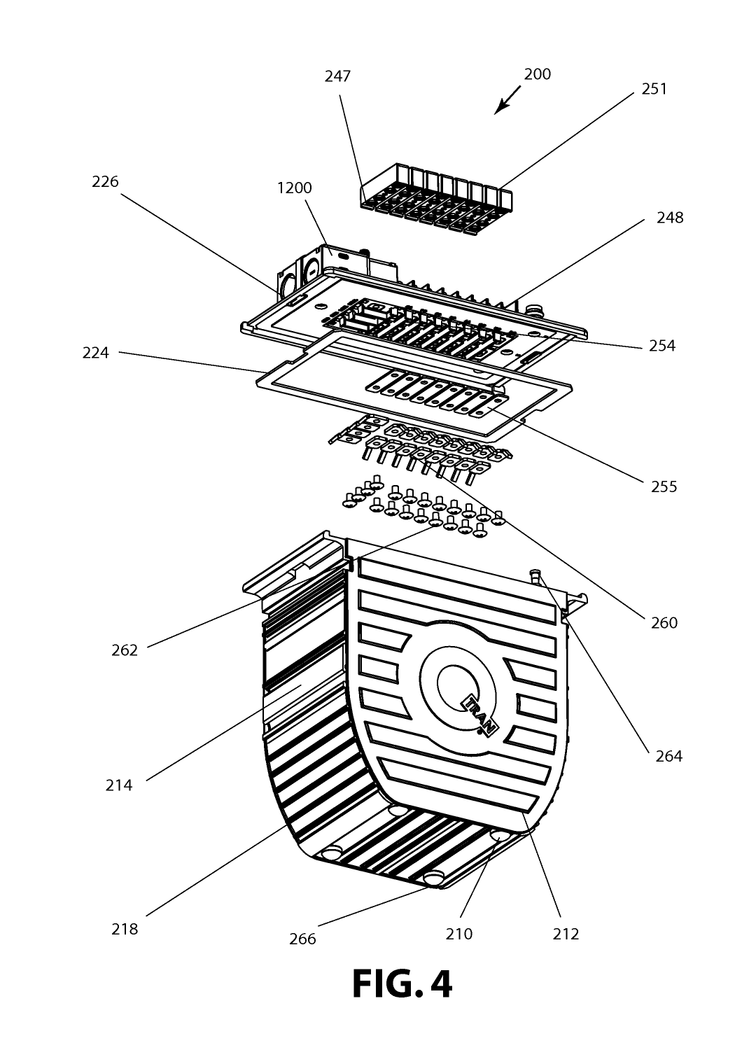

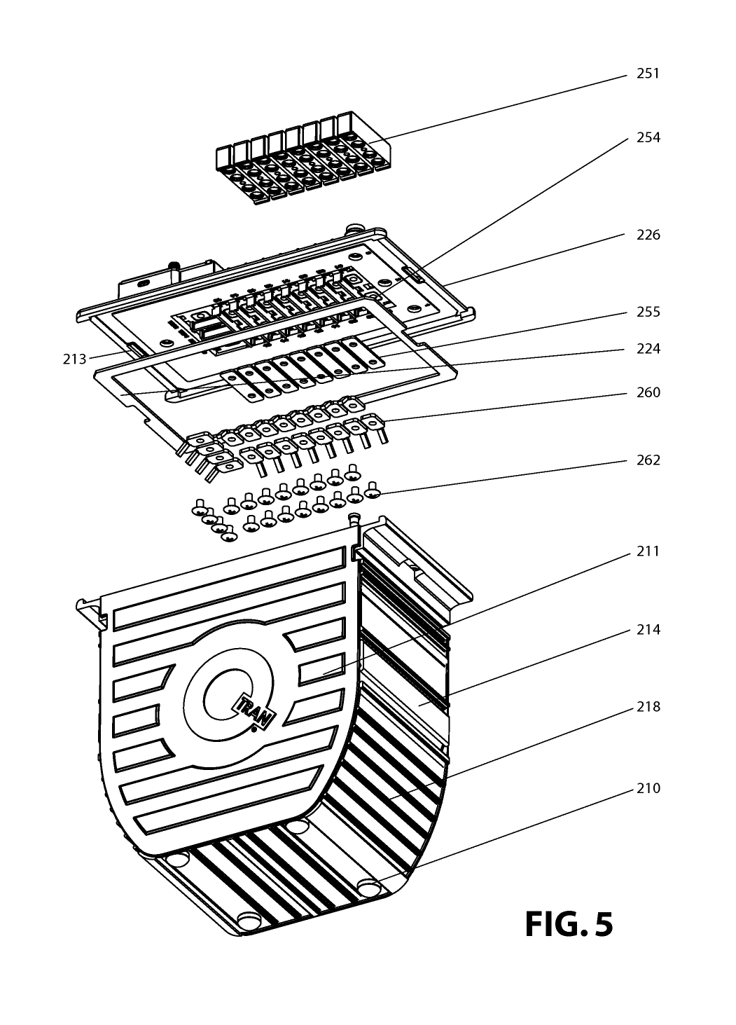

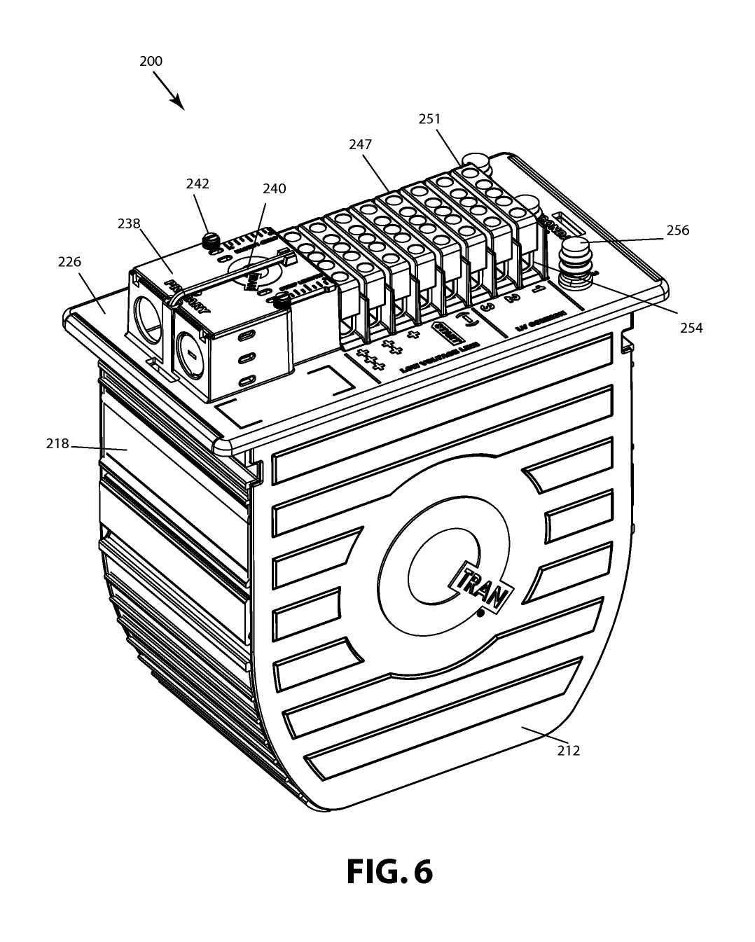

FIGS. 4, 5, 6 and 7 show another exemplary embodiment of a power supply center 200 according to the present invention. The power supply center 200 shown in FIGS. 4, 5, 6 and 7 may be configured to receive a primary voltage between 120-277V at 50 Hz or 60 Hz, and configured to output one or more secondary voltages between 11-30V. The power supply center 200 may contain a transformer (not shown) that may be a 10-1200 VA transformer. The transformer (not shown) may be a toroidal transformer. The power supply center 200 may include a primary side connected to the transformer (not shown) and configured to receive the primary voltage between 120-277V at 50 Hz or 60 Hz, and a secondary side connected to the transformer (not shown) and configured to output one or more secondary voltages between 11-30V. The transformer (not shown) may include an internal auto-reset thermal breaker to disconnect the primary side if there is an overload or an improper connection, such as an improper dimmer connection. The primary side and the secondary side each include at least one connector 155, as shown in FIGS. 12a-13e. The connector 155 shown in FIGS. 12a-13e may configured to connect at least one conductor (not shown) of a primary feed line (not shown) to the transformer, and may also be configured to connect at least one conductor (not shown) of a secondary output line (not shown) to the transformer. It is understood that the present invention is not limited to any particular transformer configuration or transformer connection to the connectors 155 of the power supply center 200.

The transformer (not shown) is positioned in an interior region of the power supply center 100. The interior region may be formed from two side plates 211, 212 positioned on each side of the transformer, and a U-shaped casing 218 or side wall positioned between to the two side plates 211, 212. The casing 218 at least defines a bounded region that includes at least the interior region of the power supply center 200. The casing 218 may be formed from two half U's joined together by a gasket (not shown) at the bottom-center of the casing 218. The casing 218 may be made from an aluminum alloy, such as 60/63-T6 aluminum alloy or equivalent. The use of aluminum alloy for the casing 218 aids in the dissipation of heat from the power supply center, however it is understood that the casing 218 may be made from other materials such as plastics or a polycarbonate resin thermoplastic. The side plates 211, 212 may be dimensioned to substantially cover a first and second side of the bounded region defined by the casing 218. The side plates 211, 212 may be made from polycarbonate resin thermoplastic, such as LEXAN® 221 or equivalent. Each side plate 211, 212 may contain one or more epoxy lock disks (not shown) positioned on the surface of the side plate 211, 212 facing the transformer (not shown) as discussed in relation to power supply center 100 shown in FIG. 1. Referring again to FIGS. 4-7, positioned between each of the side plates 211, 212 and the casing 218 is a gasket 266, which may be made from ethylene propylene diene monomer (EPDM) die cut Shore A30 or equivalent. The gasket 266 serves as a seal between the side plates 211, 212 and side wall 218 to prevent leakage of epoxy during construction of the power supply center 200.

Still referring to FIGS. 4-7, the power supply center 200 may also include a top cover 226 positioned on the upper opening of the interior region of power supply center 200 defined by the casing 218 and side plates 211, 212. A top cover gasket 224 may be placed between the top cover 226 and the upper surfaces of the casing 218 and side plates 211, 212 to prevent leakage of epoxy during construction of the power supply center 200. The top cover gasket 224 may be made from ethylene propylene diene M-class rubber (EPDM) die cut shore A30 or equivalent. PATENT

Attorney Docket No. 800-083.023-1 The top cover gasket 224 may also prevent water seepage into the power supply center 200 during use of the power supply center 200. The top cover 226 may include an enclosure 1200 as shown in Figure le on the primary side to house the connectors of the primary side. Referring again to FIGS. 4-7, the enclosure 1200 may be covered by a primary cover 238 made from polycarbonate resin thermoplastic, such as LEXAN® 940A or equivalent. The primary cover 238 may be removably secured to the enclosure 1200 by one or more thumb screws 242. The primary cover 238 may be similar to the primary cover 138 shown in FIGS. 11a-11d. A hexagonal-shaped tool 240, such as an Allen key may be removably affixed to the primary cover 238. The top cover 226 of the power supply center 200 may include one or more openings 213 for receipt of the handle strap 405 shown in FIG. 10.

Referring again to FIGS. 4-7, the power supply center 200 may also include one or more flap wing supports 214 pivotably connected to the casing 218. The one or more flap wing supports 214 may be made from an aluminum alloy, such as 60/63-T6 aluminum alloy or equivalent. The one or more flap wing supports 214 may be used to aid in the installation of the power supply center 200 by supporting the power supply center 200 at a desirable location within an enclosure (not shown) before the power supply center 200 is finally positioned within the enclosure. The power supply center 200 may also include one or more feet 210 positioned on a bottom surface of the casing 218. The one or more feet 210 may be made from generic rubber or equivalent. The power supply center 200 may include a primary circuit breaker (not shown) and one or more secondary circuit breakers 264. The primary circuit breaker (not shown) and secondary circuit breakers 264 each may be a 5A-25A circuit breaker, and/or be a hydraulic magnetic push/pull circuit breaker. Each primary circuit breaker (not shown) and each secondary circuit breaker 264 may be covered by a circuit breaker boot 256 on the exterior surface of the power supply center 200.

The power supply center 200 also includes one or more connectors 155, as discussed above with respect to FIGS. 12a-14d. The connectors 155 have a similar composition and form as shown in FIGS. 12a-14d, and are each composed of a mounting post 262, lug 260 and terminal block 254 as shown in FIG. 4. It is understood that the mounting post 262, lug 260 and terminal block 254 are combined to form the connector 155 shown in FIGS. 12a-13e. In addition, the terminal block 254 of power supply center 200 has a similar configuration to the terminal block 154 shown and discussed in detail with respect to FIGS. 14a-14d. Therefore, the discussion of the connector 155 and terminal block 254 will not be repeated here. However, on the secondary side of the power supply center 200 shown in FIGS. 4-7, two terminal blocks 254 may be connected together by a bus bar 255. The bus bar 255 may be made from a conductive material, such as 70/30 brass or equivalent, and may be plated to reduce or prevent corrosion, such plating may be nickel plating or equivalent.

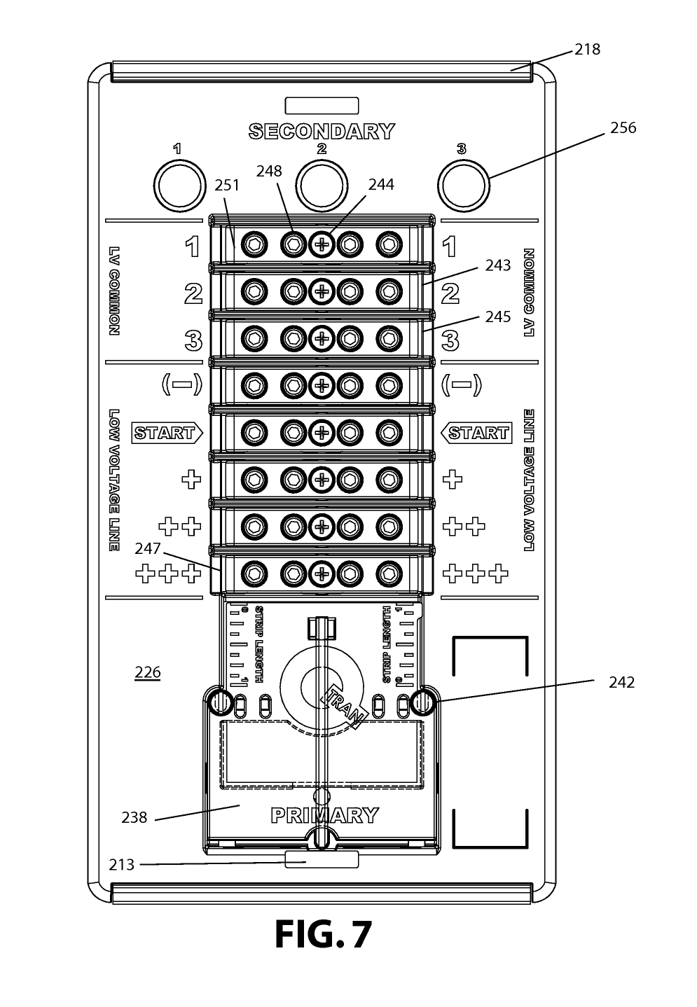

It is understood that the primary side of the power supply center 200 may be similar to the primary side of the power supply center 100 discussed in FIG. 1. The secondary side of the power supply center 200 includes two additional common connectors 243, 245 compared to the power supply center shown in FIG. 1. The common connectors 243, 245 are each comprised of two connectors shown in FIGS. 12a-13e. In addition, positioned on top of each the common connectors 243, 245 are a long terminal block cover 251. The long terminal block cover 251 is secured to the top cover 226 by a terminal block cover fastener 244, which may be a screw or equivalent fastening device. The other connectors of the secondary side of the power supply center 200 shown in FIGS. 4-7 may each also be covered by a long terminal block cover 247. The long terminal block covers 247, 251 may be color coded depending upon which connector the long terminal block covers 247, 251 are intended to cover. The long terminal block covers 247, 251 may be made from an insulating material, for example the same material used to make the terminal block covers. As shown for example in FIG. 7, the power supply center 200 may include five secondary taps on the secondary side made from the connectors. The five secondary taps provides nominal secondary voltages between 11-30V depending upon how the secondary taps are connected to the transformer (not shown). Loads may be connected to one or more of the secondary taps up to the full watt rating of the power supply center 200. Accordingly, loads at varying distances from the power supply center 200 may be tapped on different secondary taps to recover voltage drop and produce between 85-100% light output.

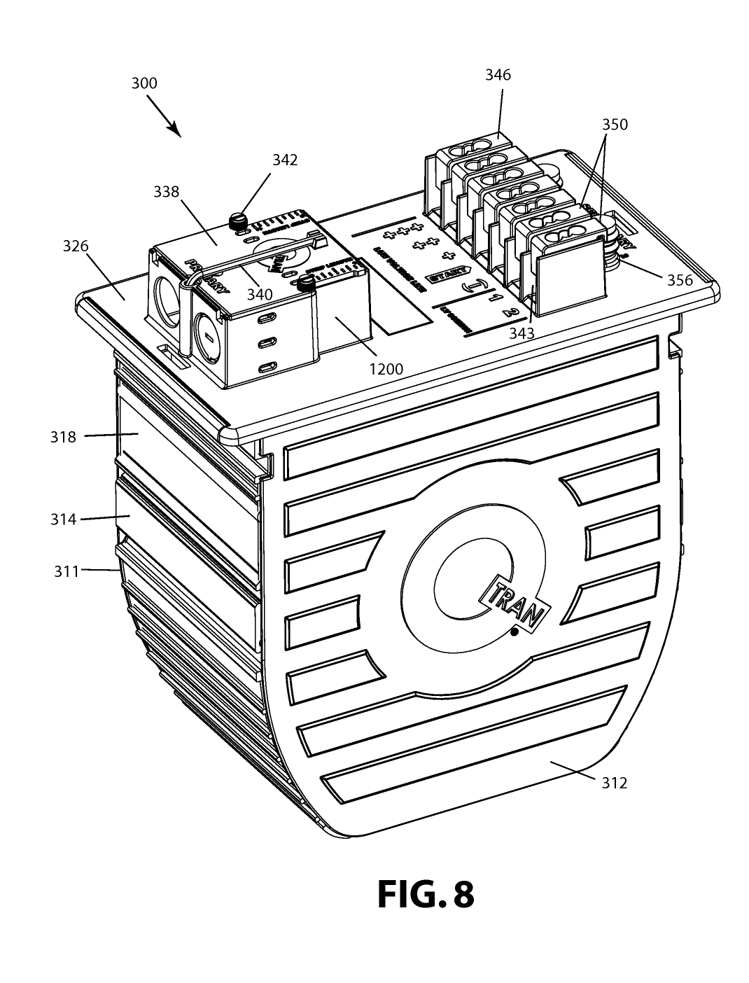

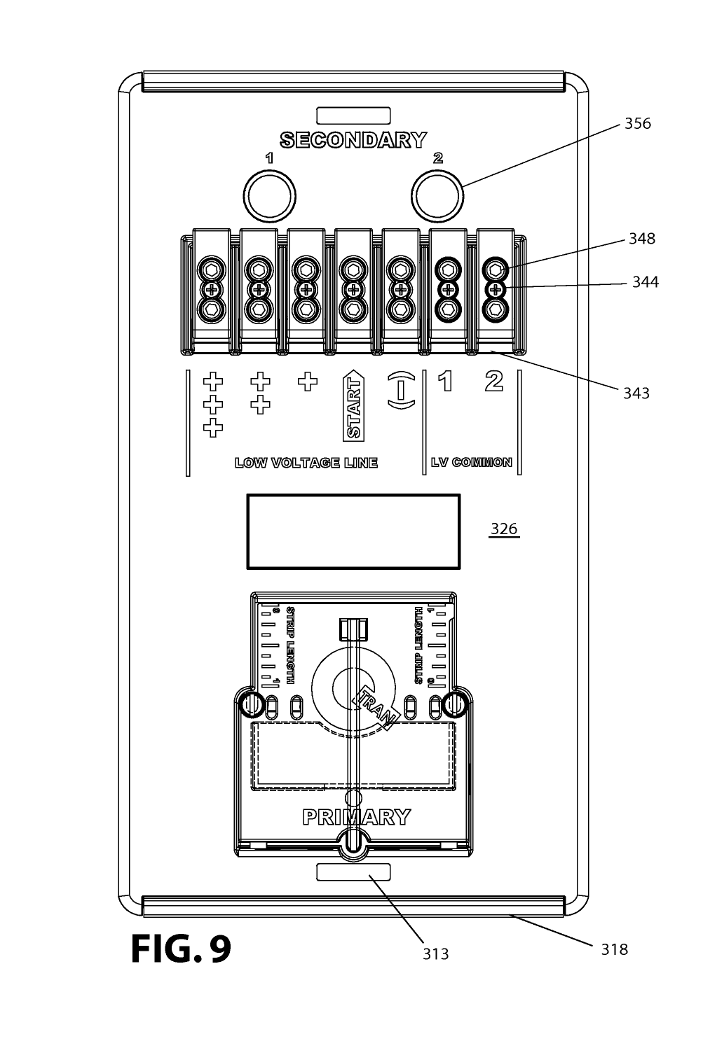

FIGS. 8 and 9 show another exemplary embodiment of a power supply center 300 according to the present invention. The power supply center 300 shown in FIGS. 8 and 9 may be configured to receive a primary voltage between 120-277V at 50 Hz or 60 Hz, and configured to output one or more secondary voltages between 11-30V. The power supply center 300 may contain a transformer (not shown) that may be a 10-1200 VA transformer. The transformer (not shown) may be a toroidal transformer. The power supply center 300 may include a primary side connected to the transformer (not shown) and configured to receive the primary voltage between 120-277V at 50 Hz or 60 Hz, and a secondary side connected to the transformer (not shown) and configured to output one or more secondary voltages between 11-30V. The transformer (not shown) may include an internal auto-reset thermal breaker to disconnect the primary side if there is an overload or an improper connection, such as an improper dimmer connection. The primary side and the secondary side each include at least one connector 155, as shown in FIGS. 12a-13e. The connector 155 shown in FIGS. 12a-13e may configured to connect at least one conductor (not shown) of a primary feed line (not shown) to the transformer, and may also be configured to connect at least one conductor (not shown) of a secondary output line (not shown) to the transformer. It is understood that the present invention is not limited to any particular transformer configuration or transformer connection to the connectors 155 of the power supply center 300.

The transformer (not shown) is positioned in an interior region (not shown) of the power supply center 300. The interior region may be formed from two side plates 311, 312 positioned on each side of the transformer, and a U-shaped casing 318 or side wall positioned between to the two side plates 311, 312. The casing 318 at least defines a bounded region that includes at least the interior region of the power supply center 300. The casing 318 may be formed from two half U's joined together by a gasket (not shown) at the bottom-center of the casing 318. The casing 318 may be made from 60/63-T6 aluminum alloy or equivalent. The side plates 311, 312 may be dimensioned to substantially cover a first and second side of the bounded region defined by the casing 318. The side plates 311, 312 may be made from polycarbonate resin thermoplastic, such as LEXAN® 221 or equivalent. Each side plate 311, 312 may contain one or more epoxy lock disks (not shown) positioned on the surface of each the side plates 311, 312 facing the transformer (not shown) as discussed in relation to power supply center 100 shown in FIG. 1. Referring again to FIGS. 8 and 9, positioned between each of the side plates 311, 312 and the casing 318 is a gasket (not shown), which may be made from ethylene propylene diene monomer (EPDM) die cut Shore A30 or equivalent. The gasket (not shown) serves as a seal between the side plates 311, 312 and side wall 318 to prevent leakage of epoxy during construction of the power supply center 300.

Still referring to FIGS. 8 and 9, the power supply center 300 may also include a top cover 326 positioned on the upper opening of the interior region of power supply center 300 defined by the casing 318 and side plates 311, 312. A top cover gasket (not shown) may be placed between the top cover 326 and the upper surfaces of the casing 318 and side plates 311, 312 to prevent leakage of epoxy during construction of the power supply center 300. The top cover gasket 324 may be made from ethylene propylene diene M-class rubber (EPDM) die cut shore A30 or equivalent. The top cover gasket 324 may also prevent water seepage into the power supply center 300 during use of the power supply center 300. The top cover 326 may include an enclosure 1200 as shown in Figure le on the primary side to house the connectors of the primary side. Referring again to FIGS. 8 and 9, the enclosure 1200 may be covered by a primary cover 338 made from polycarbonate resin thermoplastic, such as LEXAN® 940A or equivalent. The primary cover 338 may be removably secured to the enclosure 1200 by one or more thumb screws 342. The primary cover 338 may have similar features the primary cover 138 shown in FIGS. 11a-11d. A hexagonal-shaped tool 340, such as an Allen key may be removably affixed to the primary cover 338. The top cover 326 of the power supply center 300 may include one or more openings 313 for receipt of the handle strap 405 shown in FIG. 10.

The power supply center 300 may also include one or more flap wing supports 314 pivotably connected to the casing 318. The one or more flap wing supports 314 may be made from 60/63-T6 aluminum alloy or equivalent. The one or more flap wing supports 314 may be used to aid in the installation of the power supply center 300 by supporting the power supply center 300 at a desirable location within an enclosure (not shown) before the power supply center 300 is finally positioned within the enclosure. The power supply center 300 may also include one or more feet (not shown) positioned on a bottom surface of the side wall 318. The power supply center 300 may include a primary circuit breaker (not shown) and one or more secondary circuit breakers (not shown). Each primary circuit breaker (not shown) and each secondary circuit breaker (not shown) may be covered by a circuit breaker boot 356 on the exterior surface of the power supply center 300.

The power supply center 300 also includes one or more connectors 155, as discussed above with respect to FIGS. 12a-14d. The connectors 155 have a similar composition and form as shown in FIGS. 12a-14d, and are each composed of a mounting post, lug and terminal block as shown in FIGS. 12a-14d. Therefore, the discussion of the connectors and terminal blocks used with respect to power supply center will not be repeated here. It is understood that the primary side of the power supply center 300 may be similar to the primary side of the power supply center 100 discussed in FIG. 1. The secondary side of the power supply center 300 may include one additional common connector 343 compared to the power supply center 100 shown in FIG. 1. The power supply center 300 may include five secondary taps on the secondary side made from the connectors. The five secondary taps provides nominal secondary voltages between 11-30 voltages depending upon how the secondary taps are connected to the transformer (not shown). Loads may be connected to one or more of the secondary taps up to the full watt rating of the power supply center 300. Accordingly, loads at varying distances from the power supply center 300 may be connected to different secondary taps to recover voltage drop and produce between 85-100% light output.

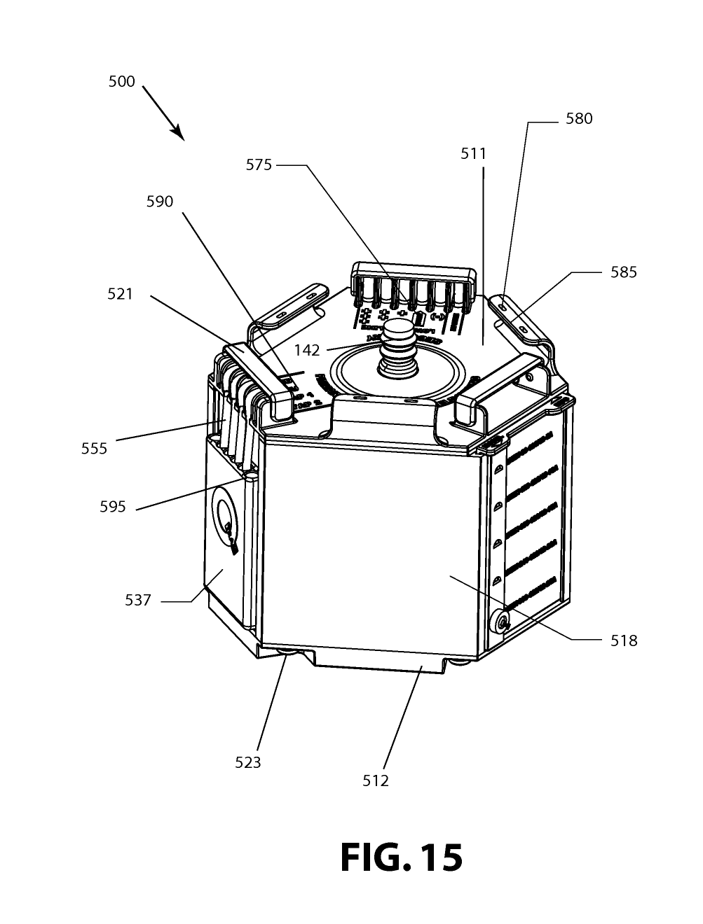

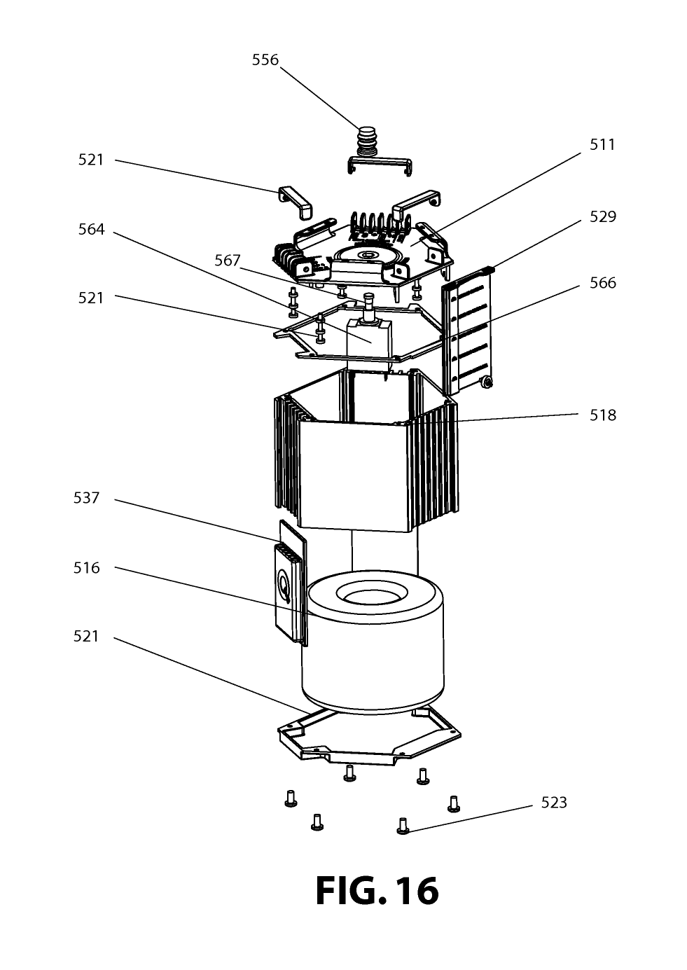

FIGS. 15 and 16 show another exemplary embodiment of a power supply center 500 according to the present invention. The power supply center 500 shown in FIGS. 15 and 16 may be configured to receive a primary voltage between 120-277V at 50 Hz or 60 Hz, and configured to output one or more secondary voltages between 11-30V. The power supply center 500 may contain a transformer 516 that may be a 10-1200 VA transformer. The transformer 516 may be a toroidal transformer, and be a 60-300 watt transformer. The power supply center 500 may include a primary side 590 connected to the transformer 516 and configured to receive a primary voltage between 120-277V at 50 Hz or 60 Hz, and a secondary side 575 connected to the transformer 516 and configured to output one or more secondary voltages between 11-30V. The transformer 516 may include an internal auto-reset thermal breaker to disconnect the primary side 590 if there is an overload or an improper connection, such as an improper dimmer connection. The primary side 590 and the secondary side 575 each include at least one connector 555. The connector 555 may be formed from a conductor that has a first end (not shown) configured for connection to the transformer 516, and a second end (not shown) configured for connection to at least one primary conductor of a primary feed line (not shown) or configured to connection to at least one secondary conductor of a secondary output line (not shown). It is understood that the present invention is not limited to any particular transformer 516 configuration or transformer 516 connection to the connectors 555 of the power supply center 500.

The power supply center 500 may also include a secondary circuit breaker 564. The secondary circuit breaker 564 may be a 5A-25A circuit breaker, and/or be a hydraulic magnetic push/pull circuit breaker. At least part of the secondary circuit breaker 564 and the transformer 516 are enclosed in an interior region of the power supply center 500 formed by a casing 518, a top plate 511 and a bottom plate 512. The casing 518 may be made from an aluminum alloy or equivalent, and the top plate 511 and bottom plate 512 may be made from polycarbonate resin thermoplastic, such as LEXAN® 221 or equivalent. The use of aluminum alloy for the casing 518 aids in the dissipation of heat from the power supply center, however it is understood that the casing 518 may be made from other materials such as plastics or a polycarbonate resin thermoplastic. A push/pull actuator 567 of the secondary circuit breaker 567 may be inserted through an opening in the top plate 511 to extend to the exterior of the power supply center 500. The push/pull actuator 567 may be covered by a push/pull boot 556, which may be made from platinum cure silicon shore A50 or equivalent. The push/pull boot 556 may form at least a substantially watertight seal with the push/pull actuator 567 and the top plate 511.

A gasket 566 may be positioned between the top plate 511 and the casing 518. The gasket 566 acts to prevent epoxy leakage from the interior region of the power supply center 500 during manufacture of the power supply center 500, and also helps to prevent water penetration into the interior region of the power supply center 500 while the power supply center 500 is in use. One or more lock posts 521 may be used to securely attach the top plate 511 to the power supply center 500 when epoxy is inserted into the interior region of the power supply center 500. The bottom plate 512 may be attached to the casing 518 and/or the power supply center 500 through use of one or more fasteners 523. The fasteners 523 may be thread forming screws or equivalent, and may be made from stainless steel or equivalent. An information panel 529 may slide to engage a side of the casing 518. The information panel 529 may contain information related to the type of transformer 516 used in the power supply center 500.

A connector cover 537 may also slide to engage another side of the casing 518. The connector cover 537 contains one or more cavities 595, each dimensioned for receipt of one connector 555. The cavities 595 of the connector cover 537 are configured to keep the connectors 555 separate. The connector cover 537 may be positioned to hold an end of the connectors 555 for both the primary side 590 and secondary side 575 of the power supply center 500. A connector management bar 521 may be positioned over the connectors 555 on the primary side 590 and/or the secondary side 575 to facilitate management of the connectors 555. The power supply center 500 may also include one or more handles 585, and one or more wire tie slots 580 in each handle 585.

The power supply center 500 may include one or more connectors 555 on the primary side 590. One connector 555 on the primary side 590 may be configured to connect a ground conductor to the power supply center 500. The transformer 516 may include a grounded isolation barrier configured for connection to the ground conductor. Another connector 555 may be configured to connect a neutral conductor to the power supply center 500. Another connector 555 may be configured to connect a hot conductor to the power supply center 500 and this connector may act as a primary tap. A fourth connector 555 may be configured to connect the hot conductor to the power supply center 500, so as to act as a second primary tap to compensate for losses that may be incurred due to connection to a dimmer (not shown). The connection of these connectors 555 to the appropriate wires (not shown) of the transformer 516 so that each connector 555 can be used as discussed above is understood to one of skill in the art. Furthermore, it is understood that the connectors 555 may be color coded.

The power supply center 500 may include five secondary taps on the secondary side 575 made from the connectors 555. The five secondary taps provides nominal secondary voltages between 11-30 voltages depending upon how the secondary taps are connected to the transformer (not shown). Loads may be connected to one or more of the secondary taps up to the full watt rating of the power supply center 500. Accordingly, loads at varying distances from the power supply center 500 may be connected to different secondary taps to recover voltage drop and produce between 85-100% light output.

It is understood that the embodiments of the power supply centers discussed above may be constructed in order to meet or exceed one or more Underwriters Laboratory (UL) standard. For example, for UL 1838, which is directed to low voltage landscape lighting systems, luminairies and power supplies must be listed as complimentary components for lighting garden, walkway, patio areas, trees and similar outdoor locations within ground and above ground fixtures, and for certain indoor locations such as atriums and shopping malls. The listing also covers luminaries submersed in or floating on ponds, rivers, water features and lakes or a portable self contained fountains per NEC Article 682 where immersed persons would not be present ad defined by luminaire installation instructions. The power supply centers discussed above may be constructed to meet or exceed the UL 1838 standard. In addition, the UL Pool & Spa standard is directed to lighting for a pool, spa, permanent fountain or other bodies of water intended to contain immersed persons, and all wirings must be Class 1 per NEC Chapter 3. The embodiments of the power supply centers discussed above may further be constructed to meet or exceed the UL Pool & Spa standard in addition to the UL 1838 standard, or independent of the UL 1838 standard. Furthermore, the UL 2108 standard covers exposed bare conductor systems comprised of cable, linear track or the like where the support structure is exposed and current carrying, and for wet locations luminaries with up to 30V input provided they are Class 1 wired per NEC Chapter 3. The embodiments of the power supply centers discussed above may further be constructed to meet or exceed the UL 2108 standard in addition to the UL 1838 and UL Pool & Spa standards, or independent of the UL 1838 and UL Pool & Spa standards. It is understood that the UL standards mentioned above are merely exemplary, and the embodiments of the power supply centers discussed above may also be constructed in a manner to meet or exceed other UL standards not specifically discussed herein.

It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A power supply center, comprising:
a casing at least partially defining a bounded region,
a first plate dimensioned to substantially cover a first opening of the bounded region, and
a second plate dimensioned to substantially cover a second opening of the bounded region,
wherein the casing, the first plate and the second plate at least partially define an interior region of the power supply center dimensioned for receipt of a transformer,
wherein the power supply center further comprises:
a primary side comprising at least one primary connector configured to connect at least one primary conductor of a primary feed line to the transformer, and
a secondary side comprising at least one secondary connector configured to connect the transformer to at least one secondary conductor of a secondary output line.

2. The power supply center of claim 1, wherein the casing is comprised of an aluminum alloy.

3. The power supply center of claim 1, further comprising at least one circuit breaker connected to the at least one secondary connector.

4. The power supply center of claim 1, further comprising at least one circuit breaker connected to the at least one primary connector.

5. The power supply center of claim 1, wherein the primary connector comprises a connector conductor comprising a first end configured for connection to the transformer and a second end configured for connection to the at least one primary conductor of the primary feed line, and wherein the first surface or the second surface comprises an opening, and the connector conductor is dimensioned to pass through the opening.

6. The power supply center of claim 5, further comprising a wire cover positioned on the casing, and comprising at least one chamber dimensioned for receipt of the second end of the connector conductor.

7. The power supply center of claim 1, wherein the secondary connector comprises a connector conductor comprising a first end configured for connection to the transformer and a second end configured for connection to the at least one secondary conductor of the secondary output line, and wherein the first surface or the second surface comprises an opening, and the connector conductor is dimensioned to pass through the opening.

8. The power supply center of claim 7, further comprising a wire cover positioned on the casing, and comprising at least one chamber dimensioned for receipt of the second end of the connector conductor.

9. The power supply center of claim 1, wherein the primary connector comprises a terminal block comprising:
a tubular housing having a passage defined therein, wherein the passage comprises a first wall and a second wall parallel to the first wall, a third wall positioned perpendicular to the first wall and the second wall, and a concave surface opposite the third wall, and wherein the passage is dimensioned for receipt of the at least one primary conductor of the primary feed line,
wherein the terminal block further comprises a pair of holes in the third wall each dimensioned for receipt of a conductor fastening device, and
a mounting post receiving opening positioned on a surface of the tubular housing opposite the pair of holes,
wherein a distance between the first wall and the second wall is substantially equal to a diameter of the conductor fastening device.

10. The power supply center of claim 1, wherein the secondary connector comprises a terminal block comprising:
a tubular housing having a passage defined therein, wherein the passage comprises a first wall and a second wall parallel to the first wall, a third wall positioned perpendicular to the first wall and the second wall, and a concave surface opposite the third wall, and wherein the passage is dimensioned for receipt of the at least one secondary conductor of the secondary output line,
wherein the terminal block further comprises a pair of holes in the third wall each dimensioned for receipt of a conductor fastening device, and
a mounting post receiving opening positioned on a surface of the tubular housing opposite the pair of holes,
wherein a distance between the first wall and the second wall is substantially equal to a diameter of the conductor fastening device.

11. The power supply center of claim 1, wherein the at least one primary connector of the primary side comprises a first primary connector, a second primary connector and a third primary connector, wherein the first primary connector is configured for connection to a ground conductor, wherein the second primary connector is configured for connection to a neutral conductor, and wherein the third primary connector is configured for connection a hot conductor.

12. The power supply center of claim 11, wherein the at least one primary connector of the primary side further comprises a fourth primary connector configured for connection to the hot conductor, and connected to the transform so as to offset voltage drop.

13. The power supply center of claim 1, wherein the at least one secondary connector of the secondary side comprises a first secondary connector and a second secondary connector, wherein the first second connector is connected to the transformer so as to provide a first output voltage, and wherein the second secondary connector is connected to the transformer so as to provide a second output voltage different from the first output voltage.

14. The power supply center of claim 13, wherein the at least one secondary connector of the secondary side further comprises a third secondary connector, a fourth secondary connector, and a fifth secondary connector, wherein the third secondary connector is connected to the transformer so as to provide s a third output voltage different from the first output voltage and the second output voltage, wherein the fourth secondary connector is connected to the transformer so as to provide a fourth output voltage different from the first output voltage, the second output voltage and the third output voltage, and wherein the fifth secondary connector is connected to the transformer so as to provide a fifth output voltage different from the first output voltage, the second output voltage, the third output voltage and the fourth output voltage.

15. The power supply center of claim 1, further comprising a third plate dimensioned to substantially cover a third opening of the bounded region, and wherein the casing, the first plate, the second plate and the third plate at least partially define the interior region of the power supply center dimensioned for receipt of the transformer.

16. The power supply center of claim 15, wherein the at least one primary connector or the at least one secondary connector is mounted on the third plate by a threaded connection post, wherein the threaded connection post is connected to the transformer, and wherein the threaded connection post is comprised of a conductive material.

17. The power supply center of claim 1, wherein the interior region is at least partially filled with an epoxy resin.

18. The power supply center of claim 1, wherein the at least one primary connector and the at least one secondary connector are comprised of a conductive material.

19. A power supply center, comprising:
a casing defining a bounded region,
a first plate dimensioned to substantially cover a first opening of the bounded region, and
a second plate dimensioned to substantially cover a second opening of the bounded region,
wherein the casing, the first plate and the second plate define an interior region of the power supply center dimensioned for receipt of a transformer,
wherein the power supply center further comprises:
a primary side comprising at least one primary connector configured to connect at least one primary conductor of a primary feed line to the transformer, and
a secondary side comprising at least one secondary connector configured to connect the transformer to at least one secondary conductor of a secondary output line,
wherein the primary connector comprises a connector conductor comprising a first end configured for connection to the transformer and a second end configured for connection to the at least one primary conductor of the primary feed line, and wherein the first surface or the second surface comprises an opening, and the connector conductor is dimensioned to pass through the opening.

20. A power supply center, comprising:
a casing at least partially defining a bounded region,
a first plate dimensioned to substantially cover a first opening of the bounded region,
a second plate dimensioned to substantially cover a second opening of the bounded region, and
a third plate dimensioned to substantially cover a third opening of the bounded region,
wherein the casing, the first plate, the second plate and the third plate define an interior region of the power supply center dimensioned for receipt of a transformer,
wherein the power supply center further comprises:
a primary side comprising at least one primary connector configured to connect at least one primary conductor of a primary feed line to the transformer, and
a secondary side comprising at least one secondary connector configured to connect the transformer to at least one secondary conductor of a secondary output line,
wherein the at least one primary connector or the at least one secondary connector is mounted on the third plate by a threaded connection post, wherein the threaded connection post is connected to the transformer, and wherein the threaded connection post is comprised of a conductive material.
